(19) United States
(12) Patent Application Publication
(10) Pub. No.: US 2020/0157313 A1
(43) Pub. Date: May 21, 2020

(54) IMIDAZOLIUM/THIOL POLYMERIZATION INITIATION SYSTEM

(71) Applicant: DENTSPLY SIRONA Inc., York, PA (US)

(72) Inventor: Xiaoming JIN, Middletown, DE (US)

(73) Assignee: DENTSPLY SIRONA Inc., York, PA (US)

(21) Appl. No.: 16/555,453

(22) Filed: Aug. 29, 2019

Related U.S. Application Data
(60) Provisional application No. 62/769,816, filed on Nov. 20, 2018.

(51) Int. Cl. C08K 5/3445; C08K 5/37; C08F 20/18

(52) U.S. Cl. CPC C08K 5/3445; C08F 20/18; C08K 5/37

(57) ABSTRACT

Described herein is a new initiator system for initiating radical polymerization of ethylenically unsaturated monomers. The initiator system comprises an organic compound having N-charged moiety in combination with an organic thiol compounds. The initiator system demonstrates better stability and is suitable for use in the field of a dentistry in formulated dual cure compositions, such as a resin modified glass ionomers, a cement, an orthodontic adhesive, and composite formulations.

### FIELD OF THE DISCLOSURE

The present disclosure relates to a new initiator system for initiating radical polymerization of ethylenically unsaturated monomers. The initiator system comprises an organic compound having N-charged moiety in combination with an organic thiol compounds. The initiator system demonstrates better stability and is suitable for use in the field of a dentistry in formulated dual cure compositions, such as a resin modified glass ionomers, a cement, an orthodontic adhesive, and composite formulations.

### BACKGROUND OF THE DISCLOSURE

Initiation is the first step of the polymerization process. During initiation, an active center is created from which a polymer chain is generated. Not all monomers are susceptible to all types of initiators. Radical initiation works best on a carbon—carbon double bond of vinyl monomers, and on a carbon—oxygen double bond of an aldehydes or ketone. Initiation has two steps. In the first step, one or two radicals are created from the initiating molecules. In the second step, the radicals are transferred from the initiator molecules to the monomer units present. Several choices are available for these initiators.

Different type of initiation and conventional initiators are known. For instance, thermal decomposition is a type of initiation wherein the initiator is heated until a bond is homolytically cleaved, producing two radicals. This method is used most often with organic peroxides or azo compounds. Other type of initiation is photolysis, wherein radiation cleaves a bond homolytically, producing two radicals. This method is used most often with metal iodides, metal alkyls, and azo compounds. Photoinitiation can also occur by bi-molecular H abstraction when the radical is in its lowest triplet excited state. An acceptable photoinitiator system should fulfill the following requirements: High absorptivity in the 300-400 nm range. Efficient generation of radicals capable of attacking the olefinic double bond of vinyl monomers. Adequate solubility in the binder system (prepolymer+monomer). Should not impart yellowing or unpleasant odors to the cured material. The photoinitiator and any byproducts resulting from its use should be non-toxic.

Yet another type of initiation is redox initiation, also known as redox catalysis, or redox activation that can be used to initiate polymerization relying on the free radicals producing in the course of oxidation-reduction reaction. A prime advantage of redox initiators is that their relative lower activation energy of the reaction can result in radical production at reasonable rates over a very wide range of temperatures, including initiation at moderate temperatures of 0-50° C. and even lower. In addition, the efficiency of different initiators or initiation processes varied and due to side reactions and inefficient synthesis of the radical species, chain initiation is not 100%. The efficiency factor f is used to describe the effective radical concentration. The maximal value of f is 1, but typical values range from 0.3 to 0.8.

Recombination pathway exists that decrease the efficiency of the initiator. For example, primary recombination wherein two radicals recombine before initiating a chain. This occurs within the solvent cage, meaning that no solvent has yet come between the new radicals. Other recombination pathways exist wherein two radical initiators recombine before initiating a chain. One radical is produced instead of the three radicals that could be produced.

In curable dental materials, the ethylenically unsaturated compounds are activated to be polymerizable by the application of light, heat or redox initiation.

There is continuing interest in finding new initiation system for the polymerization initiation of ethylenically unsaturated compound.

### SUMMARY OF THE DISCLOSURE

The present disclosure provides a new initiator system for initiating radical polymerization of ethylenically unsaturated monomers. The initiator system comprises an organic compound having N-charged moiety in combination with an organic thiol compound. The initiator system demonstrates better stability and is suitable for use in the field of a dentistry in formulated dual cure compositions, such as a resin modified glass ionomers, cements, orthodontic adhesives and composite formulations.

It is the object of the present disclosure to provide an improved dental composition comprising an initiator system comprising an organic compound having N-charged moiety in combination with an organic thiol compound.

In an embodiment of the initiator system disclosed herein, the organic compound having N-charged moiety comprises a compound of Formula I

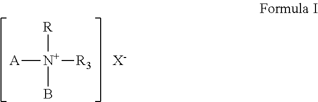

wherein
R is a linear or branched alkyl having from 3 to 18 carbon atoms;
R₃ is an alkyl having from 1 to 4 carbons or a direct bond;
X is a counter ion moiety;
A and B are independently a same or different straight or branched chain alkyl having from 1 to 8 carbons;
Or A and B together with the N form an imidazole ring,
wherein one of the N of the imidazole ring is substituted by

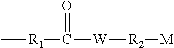

or R₃;
wherein
M is a vinyl, an allyl, a hydroxyl, an acrylate, an acrylamido, a methacrylamido or a methacrylate moiety;
R₁ is a divalent hydrocarbon radical from 2 to 10 carbons;
R₂ is a straight or branched chain alkylene having from 1 to 4 carbons;
W is O, NR₃ or a direct bond.

In another embodiment of the initiation system disclosed herein, the organic thiol is selected from cysteine; homocysteine; glutathione; pentaerythritol tetrakis(3-mercaptopropionate); dipentaerythritol hexa(3-mercaptopropionate); tetrakis(3-mercaptopropyl)silane; 2,2′-[1,2-ethanediylbis(oxy)]bisethanethiol; 1,3,5-tris(3-mercapto-2-methylpropyl)-1,3,5-triazine-2,4,6(1H,3H,5H)-trione; ethoxilated-trimethylolpropan tri(3-mercaptopropionate); 2-[Bis(2-sulfanylethoxy)-[2-[tris(2-sulfanylethoxy)silyl]ethyl]silyl]oxyethanethiol; 2-[Dimethyl-[2-[tris[2-[dimethyl(2-sulfanylethoxy)silyl]ethyl]silyl]ethyl]silyl]oxyethanethiol; 2-[(ethenyldimethylsilyl)oxy]-ethanethiol; 2,2′-[(methylphenylsilylene)bis(oxy)]bis-ethanethiol; 2,2′-[(dimethylsilylene)bis(oxy)]bis-ethanethiol; 2,2′,2″-[(methylsilylidyne)tris(oxy)]tris-ethanethiol; 2-[(trimethylsilyl)oxy]ethanethiol; tetrakis(2-mercaptoethyl) ester; 2,3-bis[(trimethylsilyl)oxy]-1-propanethiol; 2,2-bis[3,5-dimercaptomethyl)-4-(3′-propoxy)phenyl]propane; 2,2,2-tris[3,5-di-(3′-mercaptopropyl)-4-(3′-propoxy)phenyl]ethane and dodecanethiol.

In one aspect of the disclosure, a dual-cure dental composition is provided having a polymerizable monomer having at least one ethylenically unsaturated group, an organic compound having N-charged moiety; and an organic thiol compound.

In an embodiment of the dual cure dental composition, both photo-initiator and redox initiator system are used.

In yet another aspect of the disclosure, a dental composition is described. Such a dental composition includes (a) a base paste comprising an organic thiol and a polymerizable monomer having at least one ethylenically unsaturated group, and (b) a catalyst paste comprising a polymerizable monomer having at least one ethylenically unsaturated group, and an organic compound having an N-charged moiety.

In an embodiment of the dental composition, the base paste and the catalyst paste are capable of being mixed together in order to provide the dental composition.

### BRIEF DESCRIPTION OF THE DRAWINGS

FIG. 1 depicts a polymerization and structure of di(methacryloxyethyl)trimethyl-1,6-hexaethylenediurethane (UDMA)/2-phenoxyethyl (meth)acrylate (POEMA), a polymerizable nanogel via thermal free radical polymerization with azobisisobutyronitrile (AIBN) and mediated with 1-dodecanethiol (DDT) as chain transfer agent.

FIG. 2 depicts polymerization of different systems 2 Days at RT: RM1-70: ABR-E/DDT (30% mol/mol); RM1-71: EBPADMA/ABR-E (30:70 mol/mol)/DDT (30% mol/mol); RM1-72: EBPADMA/C3-IM-EGAMA (30:70 mol/mol)/DDT (30% mol/mol).

FIG. 3 depicts molecular structures of typical non-polymerizable N-charged organic polymer, Poly(ABR-E).

FIG. 4 depicts FTIR Spectrum of UDMA/POEMA/MEK/RT with variable amount of Poly(ABR-E) in 4 d.

FIG. 5 depicts FTIR Spectrum of UDMA/POEMA/MEK/RT with 5% of Poly(ABR-E) in 8 days.

FIG. 6 depicts 1H NMR Spectrum of ABR-E.

FIG. 7 depicts 1H NMR Spectrum of Poly(ABR-E)/DDT.

FIG. 8 depicts C13 NMR Spectrum of ABR-E.

FIG. 9 depicts C13 NMR Spectrum of Poly(ABR-E)/DDT.

FIG. 10 depicts FTIR Spectrum of UDMA/POEMA/DDT/MEK with Different ILs in 12 d/RT.

### DETAILED DESCRIPTION OF THE DISCLOSURE

The above-mentioned aspects, as well as other aspects, features, and advantages of the present disclosure are described below in connection with various embodiments, with reference made to the accompanying figures.

Some of the terms used in the present disclosure are defined below.

The term “alkyl”, unless otherwise specified, refers to a monoradical branched or unbranched saturated hydrocarbon chain having from 1 to 18 carbon atoms. This term can be exemplified by groups such as methyl, ethyl, n-propyl, iso-propyl, n-butyl, iso-butyl, sec-butyl, t-butyl, n-pentyl, isopentyl, neopentyl, n-hexyl, n-decyl, dodecyl, tetradecyl, and the like. Alkyl groups may be substituted further with one or more substituents selected from alkenyl, alkoxy, and hydroxyl.

The term “alkylene”, unless otherwise specified refers to a linear saturated divalent hydrocarbon radical of one to four carbon atoms or a branched saturated divalent hydrocarbon radical of three to four carbon atoms, e.g., methylene, ethylene, 2,2-dimethylethylene, propylene, 2-methylpropylene, butylene and the like, preferably methylene, ethylene, or propylene.

The term “(meth)acrylate” in the context of the present disclosure is meant to refer to the acrylate as well as to the corresponding methacrylate.

The term “(meth)acrylamide” in the context of the present disclosure is meant to include acrylamide and methacrylamide.

The term “divalent hydrocarbon radical” refers to divalent hydrocarbon radicals having 2 to 18 carbon atoms include alkylene radicals such as ethylene, methylmethylene, propylene, butylene, pentylene, hexylene and octadecylene; alkylene radicals such as vinylene, allylene and butadienylene; cycloalkylene radicals such as cyclobutylene, cyclopentylene and cyclohexylene; cycloalkenylene radicals such as cyclopentenylene and cyclohexenylene; arylene radicals such as phenylene and xenylene; aralkylene radicals as benzylene; and alkarylene radicals such as tolylene.

The term “a polymerizable monomer having at least one ethylenically unsaturated group” and “ethylenically unsaturated monomers” may be used interchangeably.

The term “counter ion moiety” refers to an ion having a charge opposite to that of the substance with which it is associated. Examples of a counter ion moiety include but are not limited to chloride, bromide, iodide, hydroxide, carboxylate, amino acid, phosphate, sulfate or nitrate.

During the thermal polymerization study of nanogel, it was accidently discovered that gelation occurred from the leftover sample of UDMA di(methacryloxyethyl)trimethyl-1,6-hexaethylenediurethane (UDMA)/ABR-E/Dodecanethiol (DDT) system after it was aged over night at room temperature in absence of any conventional initiator such as Azobisisobutyronitrile (AIBN). This event triggered further investigations.

Disclosed herein is a dental composition comprising a polymerizable monomer having at least one ethylenically unsaturated group, organic compounds containing an N-charged moiety in combination with an organic thiol compounds.

In an embodiment of the dental composition disclosed herein, organic compounds containing an N-charged moiety in combination with an organic thiol compound may be used as an initiator for polymerizing the polymerizable monomer.

In one embodiment of the dental composition disclosed herein, the organic compound having an N-charged moiety comprises a compound of Formula I

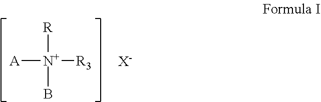

wherein
R is a linear or branched alkyl having from 3 to 18 carbon atoms;
R₃ is an alkyl having from 1 to 4 carbons or a direct bond;
X is a counter ion moiety;
A and B are independently a same or different straight or branched chain alkyl having from 1 to 8 carbons
Or A and B together with the N form an imidazole ring,
wherein one of the N of the imidazole ring is substituted by

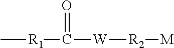

or R₃;
wherein
M is a vinyl, an allyl, a hydroxyl, an acrylate, an acrylamido, a methacrylamido or a methacrylate moiety;
R₁ is a divalent hydrocarbon radical from 2 to 10 carbons;
R₂ is a straight or branched chain alkylene having from 1 to 4 carbons;
W is O, NR₃or a direct bond.

In certain embodiment of the dental composition disclosed herein, the organic compound having an N-charged moiety comprises a compound of Formula (tBAB):

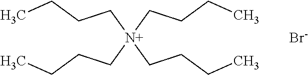 [SMILES: CCCC[N+](CCCC)(CCCC)CCCC ; [Br-]]

In certain embodiments of the dental composition disclosed herein, the organic compound having N-charged moiety comprises a compound of Formula Ia:

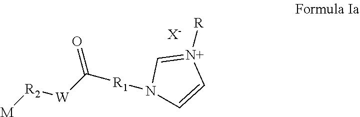

wherein
M is a vinyl, an allyl, a hydroxyl, an acrylate, an acrylamido, a methacrylamido or a methacrylate moiety;
R₁ is a divalent hydrocarbon radical from 2 to 10 carbons;
R₂ is a straight or branched chain alkylene having from 1 to 4 carbons;
R is a linear or branched alkyl having from 3 to 16 carbon atoms;
W is O, NR₃ or a direct bond;
R₃ is an alkyl having from 1 to 4 carbons; and
X is a counter ion moiety.

Examples of compounds of formula la are shown below:

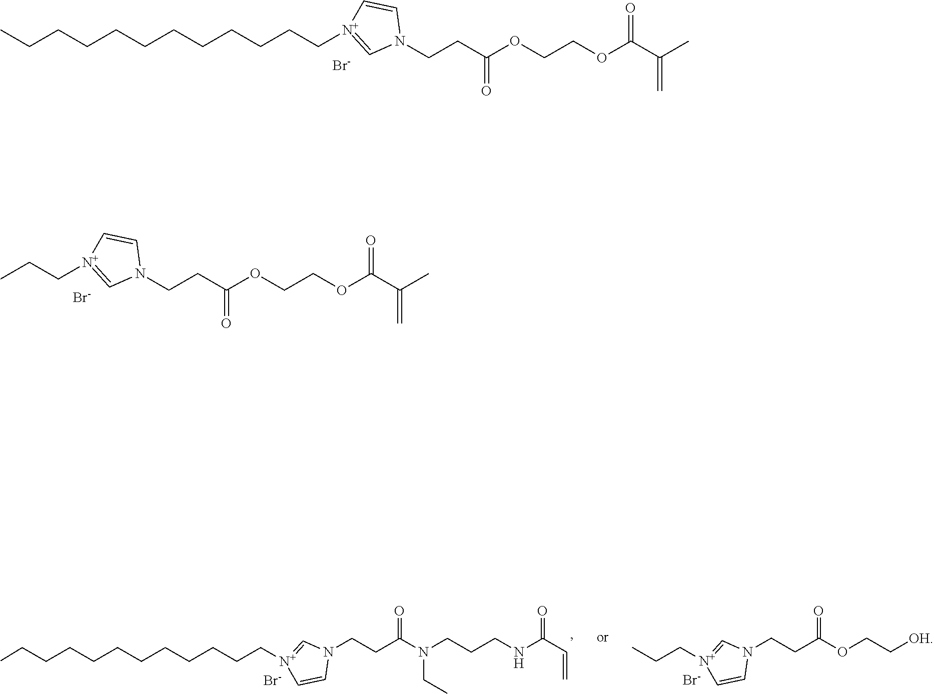

In certain embodiments of the dental composition disclosed herein, the organic compound having N-charged moiety comprises a compound of Formula Ib:

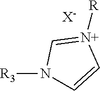

wherein R₃ is an alkyl having from 1 to 4 carbons.

Examples of compounds of formula Ib are shown below:

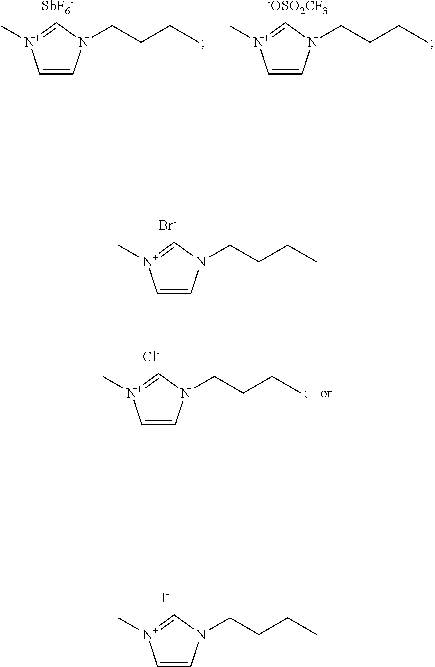

The organic compound having an N-charged moiety may be present in an amount of from 0.2 to 20% mol/mol based on total weight of all polymerizable monomers having at least one ethylenically unsaturated group, such as in a range of from 0.5 to 15% mol/mol; or from 1.0 to 10% mol/mol or any value, range, or sub-range there between, based on total weight of all polymerizable monomers having at least one ethylenically unsaturated group.

In certain embodiments of the dental composition, the organic thiol is selected from the group consisting of cysteine; homocysteine; glutathione; pentaerythritol tetrakis(3-mercaptopropionate); dipentaerythritol hexa(3-mercaptopropionate); tetrakis (3-mercaptopropyl)silane; 2,2′-[1,2-ethanediylbis(oxy)]bisethanethiol; 1,3,5-tris(3-mercapto-2-methylpropyl)-1,3,5-triazine-2,4,6(1H,3H,5H)-trione; ethoxilated-trimethylolpropan tri(3-mercaptopropionate); 2-[Bis(2-sulfanylethoxy)-[2-[tris(2-sulfanylethoxy)silyl]ethyl]silyl]oxyethanethiol; 2-[Dimethyl-[2-[tris[2-[dimethyl(2-sulfanylethoxy)silyl]ethyl]silyl]ethyl]silyl]oxyethanethiol; 2-[(ethenyldimethylsilyl)oxy]-ethanethiol; 2,2′-[(methylphenylsilylene)bis(oxy)]bis-ethanethiol; 2,2′-[(dimethylsilylene)bis(oxy)]bis-ethanethiol; 2,2′,2″-[(methylsilylidyne)tris(oxy)]tris-ethanethiol; 2-[(trimethylsilyl)oxy]ethanethiol; tetrakis(2-mercaptoethyl) ester; 2,3-bis[(trimethylsilyl)oxy]-1-propanethiol; 2,2-bis[3,5-dimercaptomethyl)-4-(3′-propoxy)phenyl]propane; 2,2,2-tris[3,5-di-(3′-mercaptopropyl)-4-(3′-propoxy)phenyl]ethane and dodecanethiol.

In one particular embodiment of the dental composition disclosed herein, the organic thiol is pentaerythritol tetrakis(3-mercaptopropionate).

In one specific embodiment of the dental composition disclosed herein, the organic thiol is dodecanethiol.

The organic thiol may be present in an amount of from 0.2 to 20% mol/mol based on total weight of all polymerizable monomers having at least one ethylenically unsaturated group; Alternatively in the range of from 0.5 to 15% mol/mol; alternatively in the range of from 1.0 to 10% mol/mol or any value, range, or sub-range there between, on total weight of all polymerizable monomers having at least one ethylenically unsaturated group.

The dental composition of the present disclosure contains a polymerizable monomer having at least one ethylenically unsaturated group.

The polymerizable monomer having at least one ethylenically unsaturated group may be selected from the group consisting of acrylates, methacrylates, an aromatic methacrylate and a hydroxy alkylmethacrylate.

Examples of specific acrylate resins include, but are not limited to, methyl acrylate, ethyl acrylate, propyl acrylate, isopropyl acrylate, 2-hydroxyethyl acrylate, hydroxypropyl acrylate, tetrahydrofurfuryl acrylate, glycidyl acrylate, glycerol mono- and di-acrylate, ethyleneglycol diacrylate, polyethyleneglycol diacrylate, neopentyl glycol diacrylate, trimethylolpropane triacrylate, mono-, di-, tri-acrylate, mono-, di-, tri-, and tetra-acrylates of pentaerythritol and dipentaerythritol, 1,3-butanediol diacrylate, 1,4-butanedioldiacrylate, 1,6-hexane diol diacrylate, 2,2′-bis[3(4-phenoxy)-2-hydroxypropane-1-acrylate]propane, 2,2′-bis(4-acryloxyphenyl)propane, 2,2′-bis[4(2-hydroxy-3-acryloxy-phenyl)propane, 2,2′-bis(4-acryloxyethoxyphenyl)propane, 2,2′-bis(4-acryloxypropoxyphenyl)propane, 2,2′-bis(4-acryloxydiethoxyphenyl)propane, and dipentaerythritol pentaacrylate esters.

Examples of specific conventional methacrylate resins include, but are not limited to, methyl methacrylate, ethyl methacrylate, propyl methacrylate, isopropyl methacrylate, tetrahydrofurfuryl methacrylate, glycidyl methacrylate, the diglycidyl methacrylate of bis-phenol A (2,2-Bis[4-(2-hydroxy-3-methacryloxypropoxy)phenyl]propane) (BisGMA), glycerol mono- and di-methacrylate, ethyleneglycol dimethacrylate, polyethyleneglycol dimethacrylate, triethylene glycol dimethacrylate (TEGDMA), neopentylglycol dimethacrylate, trimethylol propane trimethacrylate, mono-, di-, tri-, and tetra-methacrylates of pentaerythritol and dipentaerythritol, 1,3-butanediol dimethacrylate, 1,4-butanediol dimethacrylate, Bis[2-(methacryloyloxy)ethyl]phosphate (BisMEP), 1,6-hexanediol dimethacrylate, 2,2′-bis(4-methacryloxyphenyl)propane, 2,2′-bis[4(2-hydroxy-3-methacryloxy-phenyl)]propane, 2,2′-bis(4-methacryloxyethoxyphenyl)propane, 2,2′-bis(4-methacryloxypropoxyphenyl)propane, 2,2′-bis(4-methacryloxydiethoxyphenyl)propane, and 2,2′-bis[3(4-phenoxy)-2-hydroxypropane-1-methacrylate]propane.

Examples of polymerizable monomer having at least one ethylenically unsaturated group include, but not limited to, hydroxy-functional acrylic acid esters, hydroxy-functional methacrylic acid esters, halogen and hydroxy containing methacrylic acid esters and combinations thereof. 1,3-propanediol di(meth)acrylate, trimethylolpropane tri(meth)acrylate, 1,2,4-butanetriol tri(meth)acrylate, 1,4-cyclohexanediol di(meth)acrylate, pentaerythritol tetra(meth)acrylate, sorbitol hex(meth)acrylate, bis[1-(2-acryloxy)]-p-ethoxyphenyldimethylmethane, bis[1-(3-acryloxy-2-hydroxy)]-p-propoxyphenyldimethylmethane, ethoxylated bisphenol A di(meth)acrylate, and trishydroxyethyl-isocyanurate tri(meth)acrylate; (meth)acrylamides (i.e., acrylamides and methacrylamides) such as (meth)acrylamide, methylene bis-(meth)acrylamide, and diacetone (meth)acrylamide; urethane (meth)acrylates; urethane dimethacrylate (UDMA), the bis-(meth)acrylates of polyethylene glycols, and chlorine-, bromine-, fluorine-, and hydroxyl group containing monomers, for example, 3-chloro-2-hydroxylpropyl (meth)acrylate.

Examples of aromatic (meth)acrylates may include 2-phenoxyethyl(meth)acrylate, phenyl (meth)acrylate, benzoyl(meth)acrylate, benzyl (meth)acrylate, 2-phenylethyl (meth)acrylate, 3-phenylpropyl(meth)acrylate, 4-phenylbutyl (meth)acrylate, 4-methylphenyl (meth)acrylate, 4-methylbenzyl (meth)acrylate, and 2-(4-methoxyphenyl)ethyl methacrylate.

Examples of hydroxyalkylmethacrylate include hydroxyethyl (meth)acrylate (HEMA), polyethoxyethyl methacrylate, hydroxypropyl methacrylate and hydroxybutylmethacrylate, 6-hydroxyhexyl (meth)acrylate, and 10-hydroxydecyl(meth)acrylate.

In some embodiments of the present disclosure homopolymerization of a polymerizable organic compound having an N-charged moiety is disclosed.

In some embodiments of the present disclosure, copolymerization of a polymerizable organic compound having an N-charged moiety with a polymerizable monomer having at least one ethylenically unsaturated group is disclosed.

In certain embodiments of the present disclosure, the polymerizable monomer having at least one ethylenically unsaturated group is selected from the group consisting of UDMA, 2-phenoxyethyl (meth)acrylate (POEMA), ethoxylated bisphenol A dimethacrylate (EBPADMA), and benzyl methacrylate (BZMA).

Dental Composition

In certain embodiment of dental composition, a filler is included. Examples of suitable filler particles include, but are not limited to, strontium silicate, strontium borosilicate, barium silicate, barium borosilicate, barium fluoroalumino borosilicate glass, barium alumino borosilicate, calcium silicate, calcium alumino sodium fluoro phosphor-silicate lanthanum silicate, alumino silicate, and the combination comprising at least one of the foregoing fillers. The filler particles can further comprise silicon nitrides, titanium dioxide, fumed silica, colloidal silica, quartz, kaolin ceramics, calcium hydroxy apatite, zirconia, and mixtures thereof. Examples of fumed silica include OX-50 from DeGussa AG (having an average particle size of 40 nm), Aerosil R-972 from DeGussa AG (having an average particle size of 16 nm), Aerosil 9200 from DeGussa AG (having an average particle size of 20 nm), other Aerosil fumed silica might include Aerosil 90, Aerosil 150, Aerosil 200, Aerosil 300, Aerosil 380, Aerosil R711, Aerosil R7200, and Aerosil R8200, and Cab-O-Sil M5, Cab-O-Sil TS-720, Cab-O-Sil TS-610 from Cabot Corp.

The filler particles used in the composition disclosed herein may be surface treated before they are blended with organic compounds. The surface treatment using silane coupling agents or other compounds are beneficial as they enable the filler particles to be more uniformly dispersed in the organic resin matrix, and also improve physical and mechanical properties. Suitable silane coupling agents include 3-methacryloxypropyltrimethoxysilane, methacryloxyoctyltrimethoxysilane, styrylethyltrimethoxysilane, 3-mercaptopropyltrimethoxysilane, and mixtures thereof.

The filler particles can have a particle size of from about 0.002 microns to about 25 microns. In one embodiment, the filler can comprise a mixture of a micron-sized radiopaque filler such as barium alumino fluoro borosilicate glass (BAFG, having an average particle size of about 1 micron) with nanofiller particles, such as fumed silica such as OX-50 from Degussa AG (having an average particle size of about 40 nm). The concentration of micron-size glass particles can range from about 50 weight percent to about 75 weight percent of the dental composition, and the nano-size filler particles can range from about 1 weight percent to about 20 weight percent of the dental composition.

The dental composition of the present disclosure may include a filler material in an amount from about 5 to about 95 percent by weight.

The dental composition of the present disclosure may be a paste/paste composition, and may include a filler in an amount from about 5 to about 70 percent by weight.

Initiators are often used in chain-growth polymerization such as radical polymerization to regulate initiation by heat or light.

Thermal polymerization initiators are compounds that generate radicals or cations upon exposure to heat. For example, azo compounds such as 2,2′-azobis(isobutyronitrile) (AIBN) and organic peroxides such as benzoyl peroxide (BPO) are well-known thermal radical initiators, and benzenesulfonic acid esters and alkylsulfonium salts have been developed as thermal cation initiators. Organic and inorganic compounds can be used to generate radicals that initiate polymerizations. Radicals may be generated by thermal or ambient redox conditions. Decomposition rates for some initiators vary with pH and the presence of amines.

Additional free radical initiators may include organic photoinitiators. Suitable photoinitiators include Type I and Type II. They can be used independently or as mixture of different photoinitiators plus additional co-initiators. Suitable photosensitizers may include monoketones and diketones (e.g. alpha diketones) that absorb some light within a range of about 300 nm to about 800 nm (such as, about 400 nm to about 500 nm) such as camphorquinone, benzil, furil, 3,3,6,6-tetramethylcyclohexanedione, phenanthraquinone and other cyclic alpha diketones. In embodiments, the initiator is camphorquinone. Examples of electron donor compounds include substituted amines, e.g., ethyl 4-(N,N-dimethylamino)benzoate as the accelerator.

Other suitable photoinitiators for polymerizing free radical photopolymerizable compositions may include the class of phosphine oxides that typically have a functional wavelength range of from about 380 nm to about 1200 nm. In embodiments, the phosphine oxide free radical initiators with a functional wavelength range of from about 380 nm to about 450 nm are acyl and bisacyl phosphine oxides.

Commercially available phosphine oxide photoinitiators capable of free-radical initiation when irradiated at wavelength ranges of greater than from about 380 nm to about 450 nm may include 1-hydroxy cyclohexyl phenyl ketone (IRGACURE 184), 2,2-dimethoxy-1,2-diphenylethan-1-one (IRGACURE 651), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173), bis(2,4,6-trimethylbenzoyl) phenyl phosphine oxide (IRGACURE 819), bis(2,6-dimethoxybenzoyl)-(2,4,4-trimethylpentyl) phosphine oxide (CGI 403), a 25:75 mixture, by weight, of bis(2,6-dimethoxybenzoyl)-2,4,4-trimethylpentyl phosphine oxide and 2-hydroxy-2-methyl-1-phenylpropan-1-one (IRGACURE 1700), a 1:1 mixture, by weight, of bis(2,4,6-trimethylbenzoyl)phenyl phosphine oxide and 2-hydroxy-2-methyl-1-phenylpropane-1-one (DAROCUR 4265), and ethyl 2,4,6-trimethylbenzylphenyl phosphinate (LUCIRIN LR8893X).

In one embodiment of the dental composition, the initiator may be present in an amount of from 0.05 weight percent to about 5 weight percent of the dental composition.

In formulated compositions, additional additives may be included. Examples of suitable additives are ultra-violet stabilizers, fluorescent agents, opalescent agents, pigments, viscosity modifiers, fluoride-releasing agents, polymerization inhibitors, and the like. Typical polymerization inhibitors for a free radical system may include hydroquinone monomethyl ether (MEHQ), butylated hydroxytoluene (BHT), tertiary butyl hydro quinine (TBHQ), hydroquinone, phenol, butyl hydroxyaniline, and the like. The inhibitors act as free radical scavengers to trap free radicals in the composition and to extend the shelf life stability of the composition. The polymerization inhibitors, if present, may be present in amounts of from about 0.001 weight percent to about 1.5 weight percent of the dental composition, such as from about 0.005 weight percent to about 1.1 weight percent or from about 0.01 weight percent to about 0.08 weight percent of the dental composition. The composition may include one or more polymerization inhibitors.

The disclosure discussed herein is further illustrated by the nanogel compositions, dental compositions described in the following Examples, but these Examples should not be construed as limiting the scope of the present disclosure.

### Experimental Procedures

The following abbreviations may be used

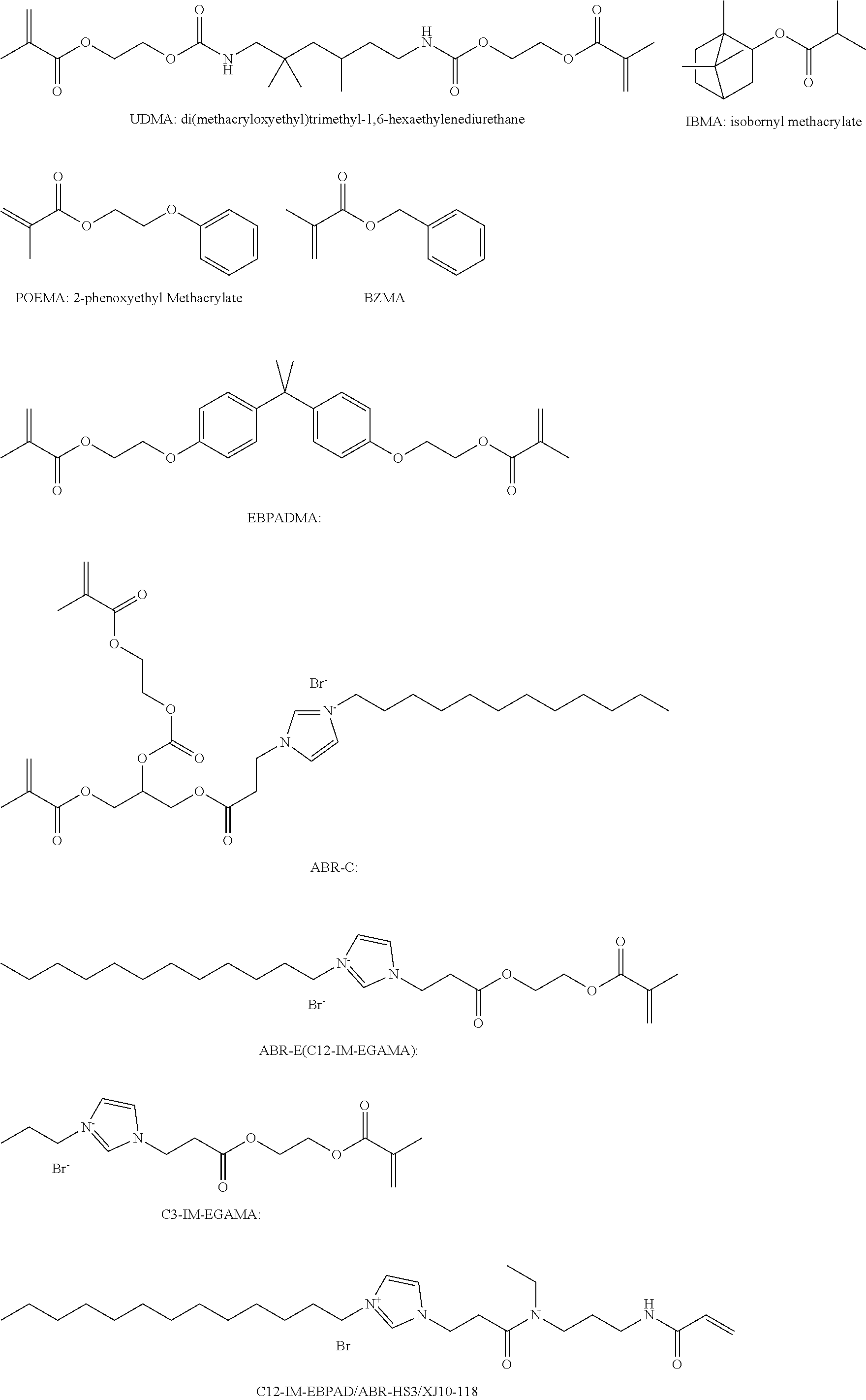

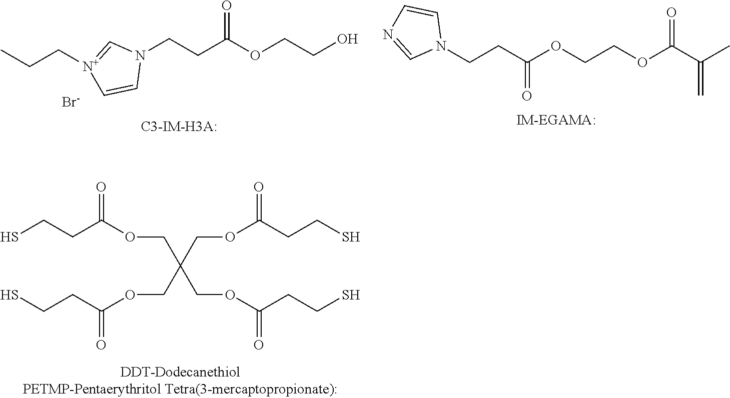

### Experimental Method

Synthetic Procedure for C12-IM-EBPAD/ABR-HS3/XJ10-118

Hydrolytically stable antibacterial monomer (C12-IM-EBPAD, ABR-HS3, XJ10-118, scheme 1) was successfully prepared from the imidazole derivative of E-BPAD [monoimidazole-monoacrylamide).

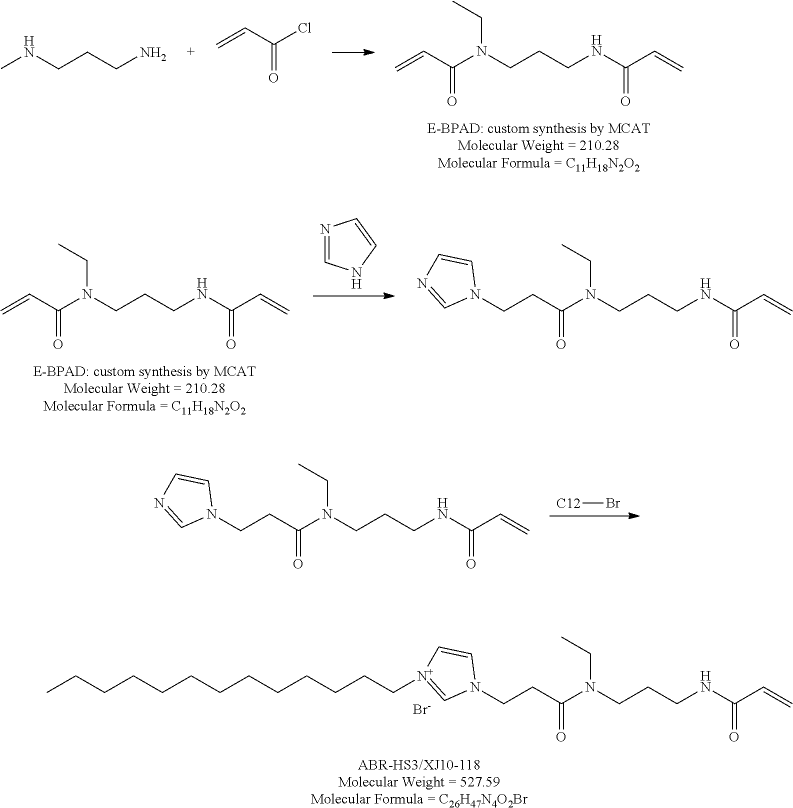

Monoimidazole-monoacrylamide was readily prepared as described below:

Unsymmetrical bisacrylamide, E-BPAD, was prepared from n-ethyl-propyl diamine and acryloyl chloride by MCAT (as shown in scheme 1). NMR analysis confirmed its structure.

It was surprisingly discovered that highly selective Michael Addition could be readily achieved with dominant addition Michael donor toward the N-substituted acrylamide(s). Very little addition occurred towards the N-nonsubstituted acrylamide(s). For example, E-BPAD was reacted with imidazole to form monoimidazole-monoacrylamide as showed in Step 2 in Scheme 1, from which the mono-imidazolium-based monoacrylamide (ABR-HS3) (scheme 1) was prepared accordingly.

Into a 250 ml three-neck round flask equipped with a mechanical agitator, 21.039 g (0.102 mol) of an unsymmetrical bisacrylamide (E-BPAD, from MCAT) was charged. 7.09 g of grounded imidazole was then added to the flask. The reaction mixture was stirred until all the reactants were completely dissolved into a homogeneous liquid at room temperature. The reaction was continued in an oil-bath at room temperature for 90 minutes (as imidazole addition to acrylamide). 0.094 g of 1,8-diazabicyclo[5,4,0]undec-7-ene (DBU) was added as a catalyst. The reaction temperature was raised to 40-50° C. and kept for an additional five weeks at 40-50° C. The reaction was monitored by NMR for it completion. 29.9 g of 1-bromododecane was added into the flask to continue directly to the next step reaction at 40° C. for three days before it was stopped. The reaction was terminated by cooling down to room temperature and adding 100 g of hexane to the reaction mixture. The hexane solution part was decanted and acetone was added to the residue. Crystals were formed from the solution. The crystals were filtered, dried and then recrystallized from acetone. NMR confirmed structure of XJ10-118 and HPLC confirmed its purity of 94%.

Synthesis of C3-IM-HEA:

C3-IM-HEA was prepared in two steps, starting from imidazole and HEA.

Into a 500 ml 3-neck flask, 116.63 g of HEA (1.0 mole), 68.36 g of imidazole (1.0 mole) and 0.30 g of diethylamine were added. The reaction mixture was stirred at room temperature overnight. The reaction was further heated up to 50° C. and the conversion was monitored by FTIR. The reaction was stopped after 6 hrs, mixed and removed from the oil bath. 180 g of low viscosity liquid was collected (IM-HEA). It was ready for use in the reaction next step.

Into a 250 ml 3-neck flask, 36.95 g of IM-HEA (0.20 mole) and 36.60 g of 1-bromopropane (0.30 mole) were added. The reaction mixture was stirred at 40° C. for two overnights in an oil-bath with no dry air purging into the reaction system. The sample was taken and dissolved in DMSO_{d6} for conversion. 100 g of acetone was added to the reaction. The top acetone solution was decanted and 50 ml of methylene dichloride was added to the bottom part to dissolve the imidazolium salt to form a solution. The solution was evaporated under reduced pressure to remove the solvent. 59.2 g of clear liquid (C3-IM-HEA in 96% yield) was collected.

Nanogel Composition

Typical nanogel composition based on UDMA and POEMA via thermal polymerization process at 80° C. in MEK is shown below.

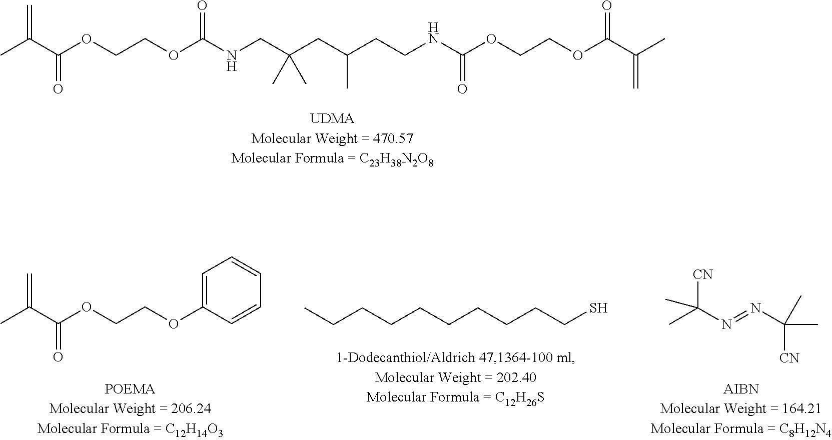

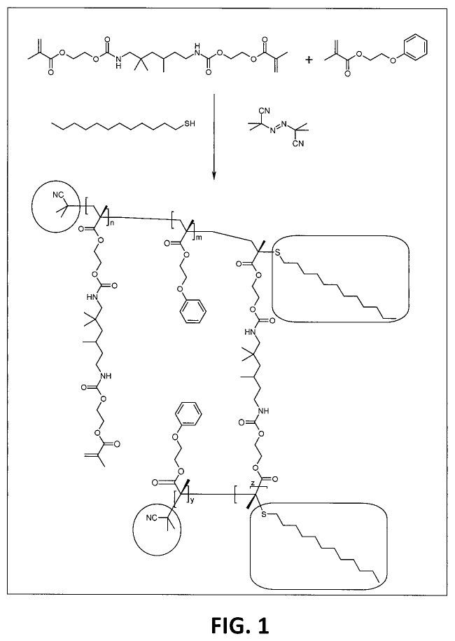

UDMA/POEMA is present as 30/70 (mole/mole) in the nanogel, AIBN as initiator and DDT as chain transfer agent are also added in the nanogel (FIG. 1). In an effort to improve the yield of Nanogel without macro-gelation, different combinations of di-methacrylates and mono-methacrylates were explored as shown in Table I. It was surprisingly noted that a high yield of more than 90% could be achieved when a charged monomer, either as dimethacrylate or as monomethacrylate in the pair as the monomer was used in producing a Nanogel.

Disclosed herein is a dental composition involving organic compounds containing a charged moiety.

TABLE I
Resin Composition for Improved Yield and Solvent Effect on Solubility of Nanogels

| | Resin Composition | | | | | Solvent | Reaction | | Solubility |
|---|---|---|---|---|---|---|---|---|---|
| | UDMA | IBMA | POEMA | ABR-C | ABR-E | Toluene(T) | Time | Yield | in |
| Nanogel | Mol % | Mol % | MoP/o | Mol % | Mol % | MEK | Min. | % | Acetone |
| XJ9-73 | | 70 | | 30 | | T | 5 | 54 | Not all |
| Example 1 | | | | | | | | | w/gelled |
| | | | | | | | | | residue |
| XJ9-76 | | 70 | | 30 | | T | 5 | 52 | Not all |
| Example 2 | | | | | | | | | w/gelled |
| | | | | | | | | | residue |
| XJ9-77 | 30 | | | | 70 | T | 5 | 92 | Not all |
| Example 3 | | | | | | | | | w/gelled |
| | | | | | | | | | residue |
| ZL1-017 | 30 | 70 | | | | T | 5 | 51 | Not all |
| Example 4 | | | | | | | | | w/gelled |
| | | | | | | | | | residue |
| ZL1-085 | 30 | 70 | | | | T | 5 | 56 | Not all |
| Example 5 | | | | | | | | | w/gelled |
| | | | | | | | | | residue |
| ZL1-141 | 30 | 70 | | | | T | 15 | 66 | Not all |
| Example 6 | | | | | | | | | w/gelled residue |
| ZL1-045 | 30 | | 70 | | | T | 5 | 66 | yes/hazy |
| Example 7 | | | | | | | | | |
| ZL1-053 | 30 | | 70 | | | T | 5 | 70 | yes/hazy |
| Example 8 | | | | | | | | | |
| ZL1-055 | 40 | | 60 | | | T | 5 | 72 | yes/hazy |
| Example 9 | | | | | | | | | |
| ZL1-111 | | | 70 | 30 | | MEK | 5 | 95 | yes/hazy |
| Example 10 | | | | | | | | | |
| ZL1-147 | | | 70 | 30 | | MEK | 5 | 76 | yes/hazy |
| Example 11 | | | | | | | | | |
| ZL1-151 | | | 70 | 30 | | MEK | 5 | 96 | yes/hazy |
| Example 12 | | | | | | | | | |

As depicted in Table I, it was found the Nanogel with N-charged comonomers would lead to a remarkably high yield of up to 95%. Thus, a new investigation was initiated to further explore the ways for improving the yield of nanogels by incorporating such N-charged monomers accordingly, that is, to synthesize novel nanogel by incorporating imidazolium-containing monomethacrylates, for examples ABR-E or C3-IM-EGAMA, as shown below, with UDMA.

Different types of reaction processes and polymer compositions were explored, such as from microwave reaction to thermal reaction, and from homopolymerization to copolymerization respectively.

Homopolymerization

The microwave reactor, Initiator plus from Biotage was used to synthesize homopolymers of the following monomethacrylates: IBMA, BZMA, POEMA, ABR-E, and C3-IM-EGAMA. Each reaction was carried out in a 25 ml vial in the microwave reactor at set reaction temperatures for variable times as shown in Table II upon the addition of AIBN. The typical reactions, excluding certain C3-IM-EGAMA, were 5.00 g batches carried out in a 25 ml vial in 10.00 g MEK (see Table II). These reactions were carried out to examine the reactivity of different monomethacrylate to screen the best candidate that would be paired with UDMA in nanogel copolymers with highest yield.

TABLE II
Effects of Homopolymerization of Monomethacrylates via Microwave Process

| | Resins | AlBN | DDT | Solvent | Reaction Temp | Reaction Time, | |
|---|---|---|---|---|---|---|---|
| Polymer | g | g | g | g | ° C. | min | Yield, % |
| RM1-27 | IBMA | 0.0519 | 1.40 | MEK | 75-76 | 10 | 0.2 |
| | 5.07 | | | 10 | | | |
| RM1-33 | BZMA | 0.0545 | 0 | MEK | 75-77 | 30 | 15.3 |
| | 5.22 | | | 10 | | | |
| RM1-21 | POEMA | 0.052S | 0 | MEK | 75-78 | 30 | 19.5 |
| | 5.13 | | | 10 | | | |
| RM1-13 | ABR-E | 0.0482 | 0.64 | MEK | 67-75 | 10 | 86.0 |
| | 5.02 | | | 10 | | | |
| RMl-35b | C3-IM EGAMA | 0.0422 | 0.96 | EtOH | 59-67 | 3 | 92.5 |
| | 4.23 | | | 8 | | | |

Both ionic monomers showed faster polymerization than conventional monomers with a higher yield.
C3-IM-EGAMA was significantly faster at 59° C., which is a much lower temperature than the normal temperature needed for AlBN system.
C3-IM-EGAMA produced an insoluble solid in MEK (solubility issues).

As shown in Table II, IBMA was unsuitable for such reactions resulting in an extremely low yield. The POEMA and BZMA reacted similarly forming a viscous, clear precipitate with low yields. For POEMA reacted without DDT, the yield increased (from 5% to 20%), but still remained low. POEMA was reacted at 75° C. at normal absorbance for 5, 10, 15 and 30 minutes with DDT and for 15 and 30 minutes without DDT. BZMA reaction at 75° C. and normal absorbance for 30 minutes produced a viscous liquid with 15% yield.

However, it was surprisingly noted a higher reactivity of both ABR-E and C3-IM-EGAMA. The highest yield of homopolymerization resulted from ABR-E and C3-IM-EGAMA accordingly. ABR-E produced a polymer with a yield of about 85% with DDT and about 95% without DDT. All ABR-E reactions were carried out at 67° C. and very high absorbance for 5 and 10 minutes with DDT, and 30 minutes without DDT. It was speculated that the high reactivity involved ABR-E and C3-IM-EGAMA might be related to the charged moiety of imidazolium and/or its potential synergetic interaction with the chain-transfer agent, DDT. It was then discovered that both ABR-E and C3-IM-EGAMA could be polymerized in the presence of DDT at room temperature and without initiator (AIBN). C3-IM-EGAMA was more reactive than ABR-E under such conditions.

The homopolymer for C3-IM-EGAMA was insoluble in methyl ethyl ketone (MEK), thus the reaction was carried out in both water and ethanol. For the reaction in water, a precipitate with 52% yield was obtained. The insolubility of DDT and AIBN in water affected the percent yield of this reaction. The reaction was then carried out at 62° C. and high absorbance because a higher temperature could not be reached. It produced a clear viscous precipitate. The C3-IM-EGAMA reaction in ethanol produced a better yield, about 97%, but only reacted for the full time at 59° C. and very high absorbance because of rapidly rising pressure. This reaction produced a viscous liquid precipitate that turned into a sticky white solid once dried under vacuum.

Copolymerization

The copolymerization between UDMA and C3-IM-EGAMA with and without the presence of POEMA in varied concentrations was examined (see Table III below). The reactions were preformed right after the addition of AIBN to ensure that no reaction occurred prior to microwave reaction. Each reaction was set for 5 minutes at varied temperatures between 60-67° C. The following reactions were carried out at very high absorbance: UDMA/C3-IM-EGAMA (30/70, mol/mol) at 60° C. and 67° C. and UDMA/C3-IM-EGAMA (20/80, mol/mol) at 60° C. The UDMA/C3-IM-EGAMA (30/70) reaction produced a precipitate with 58.4% yield at 67° C. and 45.6% yield at 60° C. The UDMA/C3-IM-EGAMA (20/80) reaction produced a precipitate with 55.3% yield at 60° C. The UDMA/C3-IM-EGAMA reaction in toluene did not reach the desired temperature or time and formed a gel which may have been caused due to insolubility of C3-IM-EGAMA in toluene. DMSO soluble solid was produced from the UDMA/C3-IM-EGAMA (20/80) reaction at 65° C. and normal absorbance. This reaction proceeded for the 5 minutes. A sticky white polymer, at 31.8% yield, formed at the bottom of the vial. Lowering the concentration of UDMA and the temperature decreased the amount of insoluble precipitate formed. The UDMA/C3-IM-EGAMA (20/80) reaction at 65° C. and normal absorbance was carried out for 10 minutes, but it produced an insoluble white solid.

TABLE III
Effects of Imidazolium-based Resins on Copolymerization with UDMA via Microwave Process

| | Composition | | | | | | Reaction | Reaction | |
|---|---|---|---|---|---|---|---|---|---|
| | UDMA | MA1 | MA2 | AlBN | DDT | Solvent | Temp | Time | Yield, |
| CoPolymer | g | g | g | g | g | g | ° C. | min | % |
| RM1-45 | 0.86 | C3-EGAMA-IM | POEMA | 0.0358 | 0.56 | MEK | 65-68 | 5 | 34.8 |
| (20/80) | | 2.67 | 0 | | | 10 | | | |
| RM1-48 | 1.94 | C3-EGAMA-IM | POEMA | 0.0509 | 1.27 | MEK | 65-68 | 5 | 14.7 |
| (20/60/20) | | 1.55 | 2.54 | | | 10 | | | |
| RM1-49 | 1.79 | ABR-E | POEMA | 0.0512 | 1.16 | MEK | 65-68 | 5 | 49.7 |
| (20/60/20) | | 1.88 | 2.37 | | | 10 | | | |

Fast polymerization and high yield was confirmed for UDMA/ABR-E system
Even fast polymerization was noticed for UDMA/C3-IM-EGAMA system as evident by the rapid formation of insoluble white solid
These facts suggested that better copolymerization should be achieved with incorporating ionic monomers

Furthermore, the catalytic effect of ionic monomer C3-IM-EGAMA and ABR-E were also examined by using UDMA/POEMA. UDMA/POEMA/C3-IM-EGAMA(20/40/40, mol/mol) and UDMA/POEMA/ABR-E(20/60/20, mol/mol) at 65° C. and normal absorbance without AIBN. The reaction of UDMA/POEMA/C3-IM-EGAMA (20/40/40, mol/mol) did not reach the desired time because of the pressure build up and then sudden decrease. An insoluble white solid (with 30.4% yield) formed on the bottom of the vial. The reaction of UDMA/POEMA/C3-IM-EGAMA (20/60/20, mol/mol) did proceed for 5 min forming a similar insoluble white solid (with 14.7% yield) on the bottom of the vial. The decanted solvent of this reaction formed a viscous precipitate in hexane. This precipitate was soluble in CDCl₃ and showed a large amount of C3-IM-EGAMA in proton NMR. All of the decanted solvent parts formed a gel like material that was insoluble in DMSO. The results showed that the insoluble precipitate was linked to the concentration of C3-IM-EGAMA and lowering the concentration decreased the percent yield of the white solid.

Copolymerization with ABR-E or C3-IM-EGAMA at Ambient Temperature Without AIBN:

The catalytic effect of ABR-E in the copolymerization of UDMA/POEMA/ABR-E (20/60/20) was explored. Two reactions were carried out and both resulted in an insoluble macrogel formation. To determine the cause of this macrogelation both a 5.00 g batch of UDMA/C3-IM-EGAMA (30:70) and a 5.00 g batch of UDMA/ABR-E (30:70) were prepared at room temperature with 30% DDT. The solution was shaken by hand to dissolve the starting material and then left on the bench to react through diffusion. The vial containing UDMA/C3-IM-EGAMA (30:70) showed signs of polymerization, forming a white solid after 2 to 3 hours which was insoluble in DMSO and CDCl₃. The vial containing UDMA/ABR-E showed a slightly slower reaction with signs of polymerization the next day. This reaction remained a viscous liquid and the precipitated product in hexane was soluble in DMSO with a drop of acetone-D. Further analysis using NMR and IR showed almost no double bond present and very low presence of the starting material. The reactivity of the ionic charged monomers in the presence of DDT explains why the microwave reactions with AIBN overreacted and produced a macrogel for C3-IM-EGAMA. This along with information from the previous experiments suggested that C3-IM-EGAMA reacted quicker than ABR-E in the presence of DDT.

The reactivity of ABR-E in the UDMA/POEMA system was explored twice using 5% DDT at room temperature, once in a stationary vial and again with stirring. The stationary vial produced an insoluble clear and white gel after one day. This gel absorbed all solvents except for water. The vial with stirring was prepared to monitor the conversion rate at 30 minutes, 90 minutes, and 120 minutes. After 120 minutes the conversion of MA was 34% which can be explained by the low amount of DDT to trigger the reaction. After 1 day the stirred vial also formed an insoluble white gel. The insoluble gel may be caused by not having adequate amount of DDT present to terminate the radical reaction causing macrogelation.

TABLE IV
Effects of N-charged Compounds on
Polymerization at RT in absence of AIBN

| | Composition | | | |
|---|---|---|---|---|
| | | N-charged | DDT, | |
| | | moiety, | % | |
| Name | Resins | % mol | mol | Observations |
| RM1-89 | UDMA | 70, ABR-E | 30 | viscous liquid, |
| | | | | 3-day, day |
| | | | | 4, 97.9% |
| | | | | conversion |
| RM1-68 | UDMA | 70, C3-IM- | 30 | white solid after |
| | | EGAMA | | a few hours |
| RM1-88 | UDMA | 70, ABR-E | 5 | 34% conversion, |
| | | | | 3-layered gel |
| | | | | second day |
| RM1-71 | EBPADMA | 70, ABR-E | 30 | opaque gel formed |
| | | | | overnight |
| RM1-72 | EBPADMA | 70, C3-IM- | 30 | white solid formed |
| | | EGAMA | | overnight |
| RM1-70 | | 100, ABR-E | 30 | remained viscous |
| | | | | liquid in MEK |
| RM1-65 | UDMA | 70, ABR-E | 30 | Room temperature |
| | | | | (82.4%) |

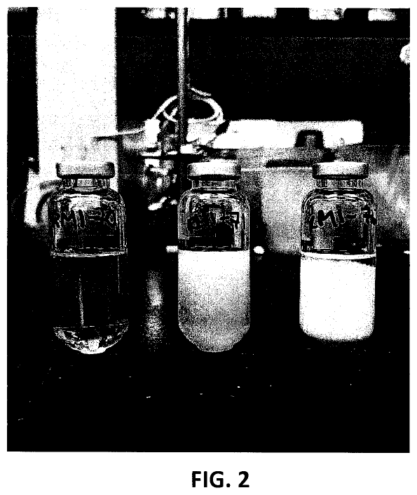

Polymerization of different systems: RM1-70: ABR-E/DDT (30% mol/mol); RM1-71: EBPADMA/ABR-E (30:70 mol/mol)/DDT (30% mol/mol); RM1-72: EBPADMA/C3-IM-EGAMA (30:70 mol/mol)/DDT (30% mol/mol) after 2 Days at room temperature is shown in (FIG. 2).

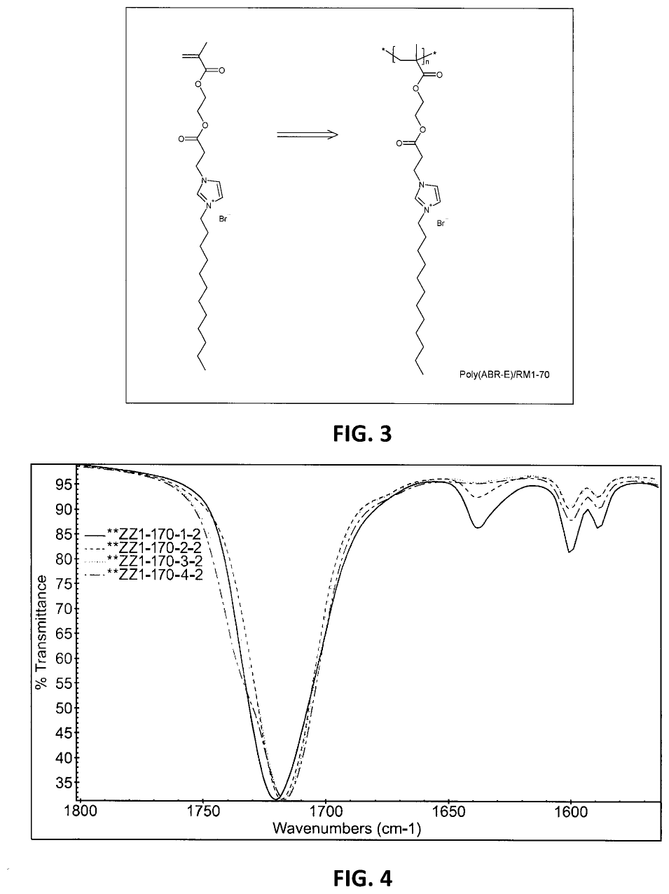

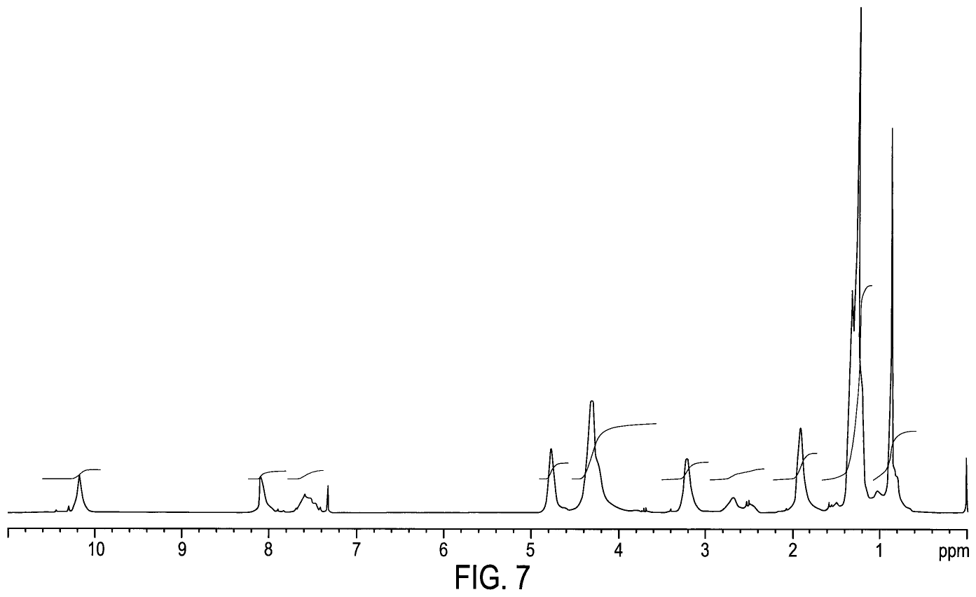

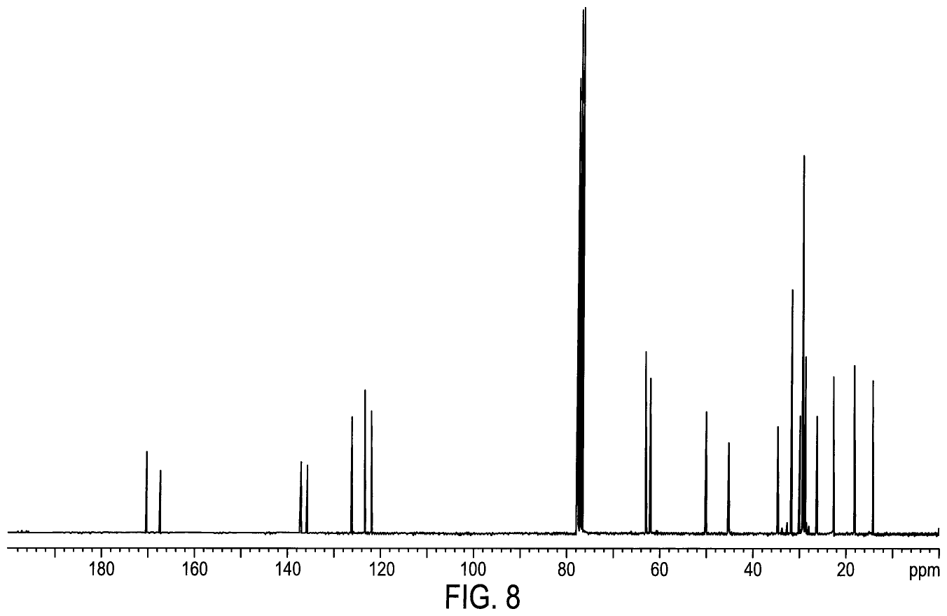

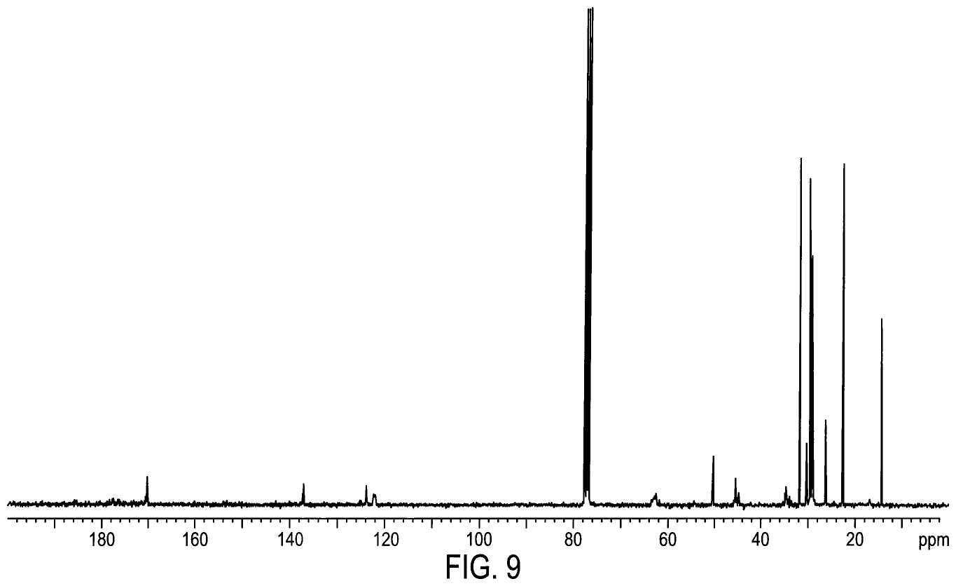

Molecular structure of typical non-polymerizable N-charged organic polymer, Poly (ABR-E) is depicted in FIG. 3. Poly (ABR-E)/DDT was characterized by 1H NMR (FIG. 7) and C13 NMR (FIG. 9).

UDMA/POEMA resin composition with different imidazolium polymer (RM1-70) at different concentrations from 0 g (ZZ1-170-1), 0.25 g (ZZ1-170-2), 0.50 g (ZZ1-170-3), 0.75 g (ZZ1-170-4), were prepared respectively. The samples were analyzed for methacrylate conversion by FTIR (FIG. 4). Very fast polymerization (gels were developed from the resin composition with higher concentration of imidazolium polymer (0.50 g (ZZ1-170-3), 0.75 g (ZZ1-170-4)) after overnight reaction at room temperature.

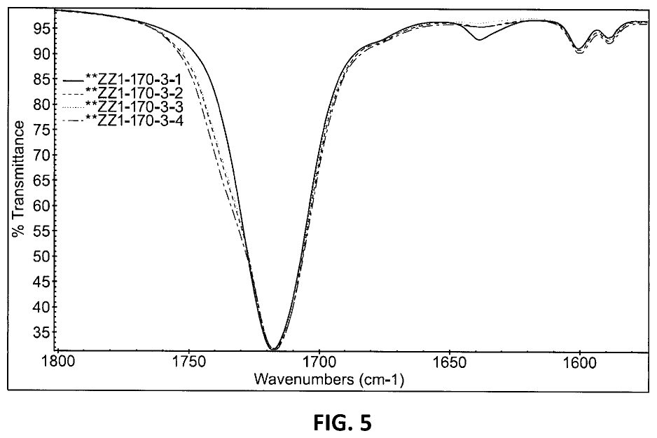

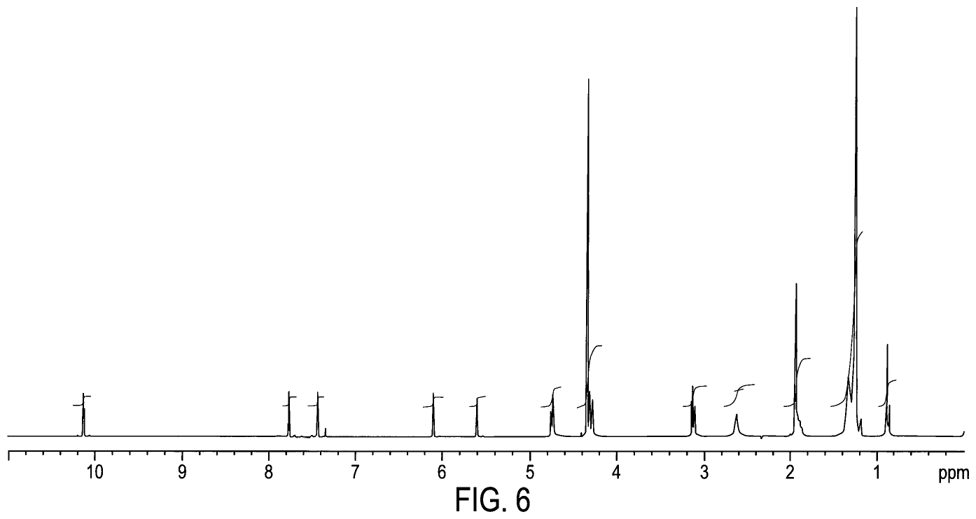

UDMA/POEMA/DDT resin compositions with variable amount of imidazolium polymer (RM1-70) were prepared. ZZ1-170-3-1: 0% wt/wt of Imidazolium polymer (RM1-70); ZZ1-170-3-2: 5.0% wt/wt of Imidazolium polymer (RM1-70); ZZ1-170-3-3: 10.0% wt/wt of Imidazolium polymer (RM1-70) and ZZ1-170-3-4: 15.0% wt/wt of Imidazolium polymer (RM1-70). Samples were taken for methacrylate conversion by FTIR (FIG. 5). Very fast polymerization (gels were developed from the resin composition with higher concentration of imidazolium polymer (10-15% wt/wt of imidazolium polymer) after overnight reaction at room temperature.

The room temperature experiments were explored to determine how rapid the reaction occurs compared to an oil bath reaction (conventional polymerization reaction at 80° C.) which took 30 minutes to reach 82% conversion. The slower reaction speed and removal from heat will help reduce the chance of macrogelation and improve the yield. This can be seen by the room temperature yield 82.4% (RM1-65) versus the oil bath reaction with 66.1% (RM1-63) at a 50g of batch size.

An additional two systems containing UDMA/POEMA at 30/70 were prepared with no AIBN: one with 5% mol/mol ABR-E (RM1-86) and the other with 5% C3-IM-EGAMA (RM1-87). These reactions were carried out at room temperature with 30% DDT in MEK. The reactions were left for 4 days before samples were taken for conversion measured by FTIR. The results did show conversion of 59% for copolymerization system with ABR-E and 63% for copolymerization system with C3-IM-EGAMA. As these reactions proceeded at ambient temperature for 10 more days, conversion of 86% for RM1-86 and 76% for RM1-87 was reached, respectively. NMR analysis on the precipitated copolymer (RM1-86) suggested that no free ABR-E was presented in the copolymer with final yield of 81.5%, which is higher than the usual 70% yield for UDMA/POEMA system. RM1-87 was slightly more insoluble in acetone creating a hazy solution and RM1-87 had a yield of 83.2%, which is consistent with the reactivity of C3-IM-EGAMA versus ABR-E. These results did confirm that the inclusion of ionic comonomers such as ABR-E or C3-IM-EGAMA could effectively improve the final yield of UDMA/POEMA.

TABLE V
Catalytic effects of Imidazolium based Systems
on Polymerization at RT in absence of AIBN

| | Composition | | | |
|---|---|---|---|---|
| | | | DDT, | |
| | | Quarz, | % | |
| Name | Resins | % mol | mol | Observations |
| RM1-76 | UDMA/ | 30, ABR-E | 30 | macrogel formed in |
| | POEMA | | | day 2 |
| RM1-98 | UDMA/ | 5, ABR-E | 30 | viscous liquid, nanogel |
| | POEMA | | | formed, 93% conversion |
| RM1-87 | UDMA/ | 5, C3-IM- | 30 | viscous liquid, nanogel |
| | POEMA | EGAMA | | formed,day 11, |
| | | | | 76% conversion |
| RM1-92 | UDMA/ | 5, C3-IM- | 30 | insoluble white solid |
| | POEMA | HEA | | formed in EtOH |
| | | | | buy soluble in MEK |
| RM1-86 | UDMA/ | 5, ABR-E | 5 | viscous liquid, nanogel |
| | POEMA | | | formed, day 11, |
| | | | | 86% conversion |
| RM1-91 | UDMA/ | 5, C3-IM- | 5 | No change in |
| | POEMA | HEA | | viscosity in day 7 |
| RM1-95 | UDMA | 70, C12- | 5 | Kind of viscose |
| | | IM-EBPAD | | liquid in day 20 |
| RM1-97 | UDMA | 70, | 5 | For conversion |
| | | ABR-E | | monitored |
| | | | | by FTIR |
| RM1-75 | UDMA/ | 0 | 30 | No polymerization |
| | POEMA | | | in 6 days/RT |
| | (30/70) | | | |
| RM1-77 | UDMA/ | 0 | 30 | No polymerization |
| | BZMA | | | in 3 days/RT |
| | (30/70) | | | |

In addition, three control reactions at room temperature were prepared to see the effect of DDT on ABR-E alone, UDMA/POEMA, and UDMA/BZMA. The control vial containing UDMA/POEMA with 30% DDT was prepared and tested by IR after 6 days. The IR showed no polymerization giving the conclusion that the reaction occurs because of the presence of the ionic charged monomer. For the ABR-E vial (RM1-70) polymerization was observed as the vial increased significantly in viscosity over the course of 14 days. After 14 days the solution was precipitated out and dried producing a yield of 99.8%. Further analysis by NMR showed no residual ABR-E leftover. This process produced the highest homopolymer yield and the only white solid that resembles a nanogel for ABR-E.

Such unexpected realization of polymerization of UDMA/POEMA (30:70) in the presence of 5% ABR-E lead to new polymerization system by using a nonpolymerizable imidazolium model compound (C3-IM-HEA) so as to verify new catalytic effect of imidazolium/DDT on the UDMA/POEMA system. For example, 5% mol/mol of C3-IM-HEA was placed in the UDMA/POEMA system with 30% DDT in ethanol. This reaction was left at room temperature to allow the UDMA/POEMA to polymerize. By the third day, the solution in the vial was foggy and a small amount of insoluble white solid formed. On the fourth day a large amount of insoluble solid was present in the foggy solution. The soluble portion was precipitated out in hexane forming a white solid. An initial NMR analysis on this precipitate showed unreacted C3-IM-HEA and POEMA still present, but the formation of insoluble copolymer should be good indication of the imidazolium/DDT indeed is capable to promote the copolymerization of UDMA/POEMA in absence of AIBN at ambient temperature.

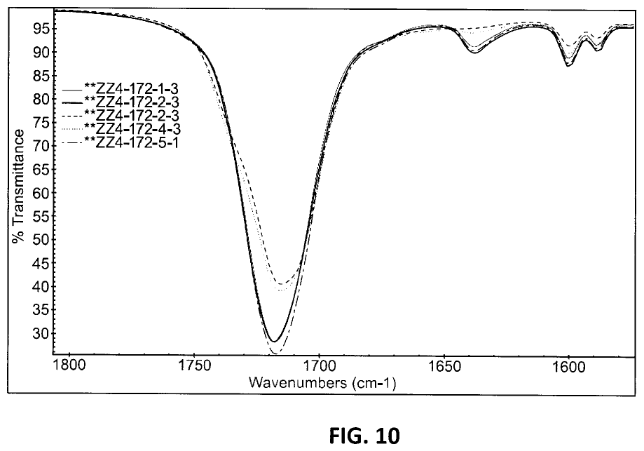

Polymerization of UDMA/POEMA/DDT/MEK with imidazolium compounds with different counter ions, like SbF₆⁻, CF₃SO₃⁻ I⁻, Br⁻, and Cl⁻, (ZZ1-172) were also explored at room temperature for 12 days. ZZ1-172-1: with 1-butyl-3-methylimidazolium iodide; ZZ1-172-2: with 1-butyl-3-methylimidazolium trifluoromethylsulfonate; ZZ1-172-3: with 1-butyl-3-methylimidazolium bromide; ZZ1-172-4: with 1-butyl-3-methylimidazolium chloride; and ZZ1-172-5: with 1-butyl-3-methylimidazolium hexafluoro antimonate. The imidazolium compounds would give significant reactivity: For example, Br⁻ and Cl⁻ are more active than I⁻, SbF₆⁻ and CF₃SO₃⁻would result in promoting radical polymerization, as evident by the methacrylate conversion (See FTIR spectrum, as depicted in FIG. 10).

Dental Composition Application Example

The inventive initiation system is used in free-radical polymerization at ambient temperature. For example, nanogel containing UDMA/POEMA synthesized with AIBN is performed at 80° C. or above to generate initiation radicals. The working time (herein specifically polymerization time) for nanogel containing UDMA/POEMA tends to be shorter with an increase in the batch size (mass) during scaling-up process. Using imidazolium/thiol system, initiation radical can be generated at an ambient temperature, such as 20-25° C. The above experimental examples support that due to the present polymerization initiator system, both a high conversion rate of the compound having a polymerizable double bond and advantageous kinetics in terms of polymerization time were obtained. The working time for nanogel containing UDMA/POEMA may be extended by adding imidazolium/DDT as initiator at low temperature polymerization (20-25° C.) for size-scaling up of Nanogel containing UDMA/POEMA. Longer working time (polymerization time) for imidazolium-based polymerization allows for better control over the polymerization process in nanogel synthesis, and the avoidance of macro-gelation. The macro-gelation has been regularly encountered during conventional thermal-initiated radical polymerization at elevated temperature.

The imidazolium-based initiation system is used in formulated paste/paste system, from which an improved shelf-life (stability) and easy cleanup is readily expected.

The paste/paste system includes a base paste and a catalyst paste. The base paste comprises an organic thiol and a polymerizable monomer having at least one ethylenically unsaturated group. The catalyst paste comprises a polymerizable monomer having at least one ethylenically unsaturated group, and an organic compound having an N-charged moiety.

The base paste and the catalyst paste are capable of being mixed together in order to provide the dental composition. The physical properties of the cured compositions are determined, using ISO specification for evaluation of work time, set time, consistency, shore A hardness, strain in compression (recovery), tear strength and depth of cure.

The imidazolium-based initiation system is used to achieve contact cure. The major limitation for such application in other redox system like peroxide/amine is due to its issue in stability. However, with imidazolium based initiation system, it is possible to achieve such a contact curing by placing restorative that contains thiols (DDT or PETMP) in contact with adhesive/primer that contains imidazolium compound, from which curing is expected to be started from the bottom of filling material upon placing contact with the adhesive layer prior to the subsequent light curing. Polymerization is able to start from bottom to top instead of top to bottom (which is featured by light cure and gap could be developed frequently). In addition, adhesive incorporated proper imidazolium might also play dual roles: antibacterial activity and co-initiator for contact cure.

While the present disclosure has been described with reference to one or more embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims. In addition, all numerical values identified in the detailed description shall be interpreted as though the precise and approximate values are both expressly identified.

1. A dual-cure dental composition comprising:
(i) a polymerizable monomer having at least one ethylenically unsaturated group,
(ii) an organic compound having an N-charged moiety, and
(iii) an organic thiol compound.

2. The composition according to claim 1, further comprising a photo-initiator system and a redox initiator system.

3. The composition according to claim 1, further comprising a filler.

4. The composition according to claim 1, wherein the organic compound having an N-charged moiety is a compound of Formula I 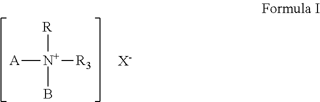
wherein
R is a linear or branched alkyl having from 3 to 18 carbon atoms;
R₃ is an alkyl having from 1 to 4 carbons or a direct bond;
X is a counter ion moiety;
A and B are independently a same or different straight or branched chain alkyl having from 1 to 8 carbons;
Or A and B together with the N form an imidazole ring,
wherein one of the N of the imidazole ring is substituted by 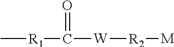
or R₃; wherein
M is a vinyl, an allyl, a hydroxyl, an acrylate, an acrylamido, a methacrylamido or a methacrylate moiety;
R₁ is a divalent hydrocarbon radical from 2 to 10 carbons;
R₂ is a straight or branched chain alkylene having from 1 to 4 carbons;
W is O, NR₃or a direct bond.

5. The composition according to claim 4, wherein the organic compound having an N-charged moiety is a compound of Formula Ia: 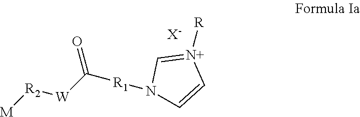
wherein
M is a vinyl, an allyl, a hydroxyl, an acrylate, an acrylamido, a methacrylamido or a methacrylate moiety;
R₁ is a divalent hydrocarbon radical from 2 to 10 carbons;
R₂ is a straight or branched chain alkylene having from 1 to 4 carbons;
R is a linear or branched alkyl having from 3 to 16 carbon atoms;
W is O, NR₃ or a direct bond;
R₃ is an alkyl having from 1 to 4 carbons; and
X is a counter ion moiety.

6. The composition according to claim 1, wherein the organic thiol is selected from the group consisting of cysteine; homocysteine; glutathione; pentaerythritol tetrakis(3-mercaptopropionate); dipentaerythritol hexa(3-mercaptopropionate); tetrakis (3-mercaptopropyl)silane; 2,2′-[1,2-ethanediylbis(oxy)]bisethanethiol; 1,3,5-tris(3-mercapto-2-methylpropyl)-1,3,5-triazine-2,4,6(1H,3H,5H)-trione; ethoxilated-trimethylolpropan tri(3-mercaptopropionate); 2-[Bis(2-sulfanylethoxy)-[2-[tris(2-sulfanylethoxy)silyl]ethyl]silyl]oxyethanethiol; 2-[Dimethyl-[2-[tris[2-[dimethyl(2-sulfanylethoxy)silyl]ethyl]silyl]ethyl]silyl]oxyethanethiol; 2-[(ethenyldimethylsilyl)oxy]ethanethiol; 2,2′-[(methylphenylsilylene)bis(oxy)]bis-ethanethiol; 2,2′-[(dimethylsilylene)bis(oxy)]bis-ethanethiol; 2,2′,2″-[(methylsilylidyne)tris(oxy)]tris-ethanethiol; 2-[(trimethylsilyl)oxy)]ethanethiol; tetrakis(2-mercaptoethyl) ester; 2,3-bis[(trimethylsilyl)oxy]-1-propanethiol; 2,2-bis[3,5-dimercaptomethyl)-4-(3′-propoxy)phenyl]propane; 2,2,2-tris[3,5-di-(3′-mercaptopropyl)-4-(3′-propoxy)phenyl]ethane and dodecanethiol.

7. The composition according to claim 6, wherein the organic thiol is pentaerythritol tetrakis(3-mercaptopropionate).

8. The composition according to claim 6, wherein the organic thiol is dodecanethiol.

9. The composition according to claim 1, wherein the organic thiol is present in a concentration of from 0.2 to 20% mol/mol based on a total weight of all polymerizable monomers having at least one ethylenically unsaturated group.

10. The composition according to claim 1, wherein the organic compound having an N-charged moiety is present in an amount of from 0.2 to 20% mol/mol based on a total weight of all polymerizable monomers having at least one ethylenically unsaturated group.

11. The composition according to claim 1, wherein the composition is in a form of a two component composition.

12. The composition according to claim 11, wherein the two component composition is a paste/paste system.

13. A dental composition comprising: (a) a base paste comprising an organic thiol and a polymerizable monomer having at least one ethylenically unsaturated group, and (b) a catalyst paste comprising a polymerizable monomer having at least one ethylenically unsaturated group, and an organic compound having an N-charged moiety;
wherein the base paste and the catalyst paste are capable of being mixed together in order to provide the dental composition.

14. An initiator system for radical polymerization of ethylenically unsaturated monomers comprising:
(a) an organic compound having N-charged moiety, and
(b) an organic thiol compound.

15. The initiator system according to claim 14, wherein the organic compound having an N-charged moiety is a compound of Formula I: 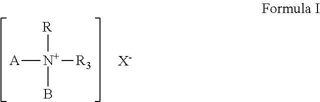
wherein
R is a linear or branched alkyl having from 3 to 18 carbon atoms;
R₃ is an alkyl having from 1 to 4 carbons or a direct bond;
X is a counter ion moiety;
A and B are independently a same or different straight or branched chain alkyl having from 1 to 8 carbons
Or A and B together with the N form an imidazole ring,
wherein one of the N of the imidazole ring is substituted by 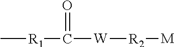
or R₃; wherein
M is a vinyl, an allyl, a hydroxyl, an acrylate, an acrylamido, a methacrylamido or a methacrylate moiety;
R₁ is a divalent hydrocarbon radical from 2 to 10 carbons;
R₂ is a straight or branched chain alkylene having from 1 to 4 carbons;
W is O, NR₃or a direct bond.

16. The initiator system according to claim 15, wherein the organic compound having an N-charged moiety comprises a compound of Formula Ia: 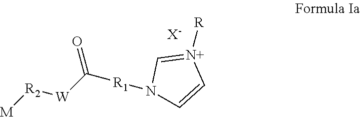
wherein
M is a vinyl, an allyl, a hydroxyl, an acrylate, an acrylamido, a methacrylamido or a methacrylate moiety;
R₁ is a divalent hydrocarbon radical from 2 to 10 carbons;
R₂ is a straight or branched chain alkylene having from 1 to 4 carbons;
R is a linear or branched alkyl having from 3 to 16 carbon atoms;
W is O, NR₃or a direct bond;
R₃ is an alkyl having from 1 to 4 carbons; and
X is a counter ion moiety.

17. The initiation system according to claim 14, wherein the organic thiol is selected from the group consisting of cysteine; homocysteine; glutathione; pentaerythritol tetrakis(3-mercaptopropionate); dipentaerythritol hexa(3-mercaptopropionate); tetrakis(3-mercaptopropyl)silane; 2,2′-[1,2-ethanediylbis(oxy)]bisethanethiol; 1,3,5-tris(3-mercapto-2-methylpropyl)-1,3,5-triazine-2,4,6(1H,3H,5H)-trione; ethoxilated-trimethylolpropan tri(3-mercaptopropionate); 2-[Bis(2-sulfanylethoxy)-[2-[tris(2-sulfanylethoxy)silyl]ethyl]silyl]oxyethanethiol; 2-[Dimethyl-[2-[tris[2-[dimethyl(2-sulfanylethoxy)silyl]ethyl]silyl]ethyl]silyl]oxyethanethiol; 2-[(ethenyldimethylsilyl)oxy]ethanethiol; 2,2′-[(methylphenylsilylene)bis(oxy)]bis-ethanethiol; 2,2′-[(dimethylsilylene) bis(oxy)]bis-ethanethiol; 2,2′,2″-[(methylsilylidyne)tris(oxy)]tris-ethanethiol; 2-[(trimethylsilyl)oxy]-ethanethiol; tetrakis(2-mercaptoethyl) ester; 2,3-bis[(trimethylsilyl)oxy]-1-propanethiol; 2,2-bis[3,5-dimercaptomethyl)-4-(3′-propoxy)phenyl]propane; 2,2,2-tris[3,5-di-(3′-mercaptopropyl)-4-(3′-propoxy)phenyl]ethane and dodecanethiol.

18. The initiation system according to claim 17, wherein the organic thiol is pentaerythritol tetrakis(3-mercaptopropionate).

19. The initiation system according to claim 17, wherein the organic thiol is dodecanethiol.

20. The initiation system according to claim 14, wherein the organic thiol is present in a concentration of from 0.2 to 20% mol/mol based on a total weight of unsaturated monomers.

21. The initiator system according to claim 14, wherein the organic compound having an N-charged moiety can be polymerizable or non-polymerizable.

22. The initiation system according to claim 14, wherein the organic compound having an N-charged moiety is present in a concentration of from 0.2 to 20% mol/mol based on a total weight of unsaturated monomers.
